(19) United States
(12) Patent Application Publication
(10) Pub. No.: US 2015/0299612 A1
(43) Pub. Date: Oct. 22, 2015

(54) Process

(71) Applicant: GIVAUDAN SA, Vernier (CH)

(72) Inventors: Robin CLERY, Horgen (CH); Eric EICCHORN, Zurich (CH); Esther LOCHER, Duebendorf (CH)

(73) Assignee: GIVAUDAN SA, Vernier (CH)

(21) Appl. No.: 14/650,057

(22) PCT Filed: Jan. 3, 2014
(86) PCT No.: PCT/EP2014/050054

§ 371 Date: Jun. 5, 2015

(30) Foreign Application Priority Data
Jan. 3, 2013 (GB) 1300073.2

(51) Int. Cl. C11B 3/00

(52) U.S. Cl. CPC C11B 3/003

(57) ABSTRACT

A method of removing the blue colour from an azulene-containing essential oil, comprising the addition of the oil to water buffered at pH 3-7.5 and its subsequent treatment with a laccase enzyme-mediator system, the laccase being selected from those derived from Trametes sp. and Myceliophthora thermophila in the presence of a mediator. Decoloured oils may be used in perfumery, where their colour was previously a major disadvantage.

This disclosure relates to the decolouration of essential oils.

Certain essential oils, notably those of the genera Chamomilla, Matricaria, Anthemis (chamomiles), the genus Artemisia (absinthe, mugwort, wormwood, wormseed etc) and the genus Achillea (yarrow) are blue-coloured, ranging from a blue-green to a very deep blue colour. This is as a result of the presence therein of various azulenes, notably azulene, chamazulene, dihydrochamazulene and guiazulene. (In this description, the term “azulene” is used to cover all azulenes that have this characteristic colour). This colour is undesirable, as it restricts the usefulness of these otherwise desirable oils in perfumery, but hitherto it has been difficult or impractical to remove.

It has now been found that such oils can be essentially completely decoloured by the application of a simple technique. There is therefore disclosed a method of removing the blue colour from an azulene-containing essential oil, comprising the addition of the oil to water buffered at pH 3-7.5 and its subsequent treatment with a laccase enzyme-mediator system, the laccase being selected from those derived from Trametes sp. and Myceliophthora thermophila.

Many laccase enzymes are known, and they have been used for various purposes, such as the synthesis of desirable molecules in the fragrance and flavour field. However, it has not previously been known that those derived from Trametes sp. or Myceliophthora thermophila can be used to decolour essential oils.

Examples of commercially-available laccase enzymes useful in this method include, but are not limited to, Laccase C (ASA Spezialenzyme GmbH), and laccase NS 42035 (Novozymes A/S).

The presence of a mediator is essential to the process. By “mediator” is meant a low molecular weight organic compound, which is a substrate for the laccase enzyme and which mediates the reaction between the laccase and an azulene. By “mediates the reaction” is meant that (a) it is oxidised by the enzyme, (b) it in turn oxidises the azulene, and (c) it is reactivated by the enzyme for further reaction. The use of mediators in laccase systems is well known to the art, and many such mediators are known. Examples are described in, for example, Camarero et al (Appl Env Microbiol 71, 1775-1784, 2005), Fabbrini et al (J Mol Cat B: Enz 16, 231-240, 2002), Gonzalez Arzola et al (Electrochemica Acta 54, 2621-2629, 2009).

Some non-limiting specific examples include sinapic acid, methyl syringate, arbutin, 1-hydroxybenzotriazole, TEMPO, phenothiazine, phenol red, 4-hydroxybenzoic acid, tyrosol, ethyl vanillin and mesitol. In addition, there are commercially available laccase-mediator systems, one such system being Denilite™ II S, the mediator in this case being methyl syringate.

While the use of a Myceliophthora thermophila-derived laccase enzyme usually requires an added mediator for effective decolouration, it has been noted that certain of the laccase enzymes of Trametes sp. can decolour certain oils in the absence of added mediator.

Examples of such oils include Australian blue Cypress oil (Callitris intratropica), Wormwood oil (Artemisia absinthum), Blue Chamomile oil (Matricaria chamomilla) and Chiba oil (Artemisia arborescens.). It is believed, without restricting the disclosure in any way, that there is present in these oils compounds that are capable of acting as mediators, for example, thymol (in Artemisia oils). However, for the purposes of this disclosure, the use of Trametes sp.-derived laccase enzyme alone is considered to fall within the ambit of “laccase enzyme—mediator system” hereinabove defined.

In any case, the addition of a mediator is observed to enhance noticeably the decolouring performance of Trametes sp.-derived laccase enzymes. In some cases, for example, Cape camomile oil (Eriocephalus punctulatus) and Roman camomile oil (Anthemis nobilis), a mediator is needed for acceptable decolouring. A suitable mediator/enzyme/oil combination may be found by routine, non-inventive experimentation. A particular laccase-mediator system is Trametes sp.-1-hydroxybenzotriazole.

Commercially-available laccase preparations are generally supplied as dry powders with a specified activity. It is well known that this activity diminishes over time, sometimes considerably (factors of more than 10 are not uncommon), so prior to use, it is essential to determine how much active laccase remains in the laccase preparation, so that an appropriate quantity may be used. This is standard practice for anyone working with enzymes.

The quantity of enzyme that will be needed for a particular decoloration will depend on the specific activity of the laccase. By “laccase specific activity” is meant the number of active laccase units/mg of laccase preparation. The determination of specific activity in a laccase preparation (in laccase Units) is performed according to well-known and—used biochemical procedures, an iterative cycle of trial and error beginning with a randomly chosen amount of laccase preparation.

A typical example is described in the following paragraph. In this case, syringaldazine as substrate, and all activities in this description are relative to this standard.

To 1 ml reaction in 40 mM MES buffer pH 5.3 was added an aliquot of accurately prepared aqueous solution of laccase preparation. The reaction was started by adding syringaldazine (Sigma S7896) to 33 μM final concentration from a stock solution made in ethanol. The increase of absorbance (pink colour formation) was recorded for 10 min at 22° C. at 525 nm in a Cary 1 UV-VIS spectrophotometer (Varian). Measurements were done against a blank consisting of MES buffer. The specific activity is measured in Units, where one Unit is defined as the amount of laccase preparation catalyzing the oxidation of 1 nanomole of syringaldazine per minute under the above conditions.

The proportion of mediator required depends on the natures of the oil and the mediator, and there is a wide range of possibilities. Typically the mediator concentration is from 0.05-100 mM, although there may be instances of concentrations outside this range delivering acceptable results.

The method is typically carried out by adding the oil to water buffered to pH 3-7.5 (particularly 4.5-5.5) under continuous agitation. As much oil as is possible may be added (typically up to 50% by weight; in some cases, more is possible). The laccase-mediator system is then added in liquid or powder form. The reaction is carried out at between 20°-80° C., particularly about 35°-45° C. Depending on the oil and the laccase-mediator system used, decolouration is usually complete in 3.5 to 7 h, although some oils may require up to 24 h. In some cases, the addition of a larger amount of a laccase-mediator system will give a faster decoloration. However, this is not always the case, but routine experimentation can easily distinguish where this works and where it does not.

The decoloured oil may be recovered by standard techniques, such as decanting and solvent extraction

The result is a colourless oil that is useful in perfumery. There is therefore disclosed a decoloured azulene-containing essential oil, preparable by the method hereinabove described.

The disclosure is further described with reference to the following non-limiting examples.

### EXAMPLE 1

A reaction (500 microliter final volume) was set up as follows : 430 μl of 0.1 M citric acid-sodium phosphate buffer pH 5.0 supplemented with 0.25% Tween™ 80 surfactant and containing 2.2 mg Trametes sp. Laccase C (corresponding to 171 Units, units as described above) was placed into a 3 ml glass vial. 50 μl of deep blue chamomile very heavy blue oil (Frith Farm) was then added. The reaction was started by the addition of 20 μl of mediator 1-hydroxybenzotriazole prepared as 50 mM stock solution in ethanol. The glass vial was capped and incubated at 40° C. with constant agitation at 250 rpm on an orbital shaker. The progress of the decolouration was assessed after 3.5 and 7 hours of incubation in comparison with the original colour, by stopping the reaction and extracting with isopropanol. Particulate and precipitated materials were removed by centrifugation prior to analysis. After 7 hours of reaction the blue colour had completely disappeared, leaving a pale yellow to pale brownish oil suitable for use in fragrances, so a proposed further evaluation at 24 hours was not necessary. Decolouration was evaluated by absorbance measurement (Example 5) and gas chromatography (GC-FID) analysis (Example 6). Blank reactions were prepared and run the same way with the exception that no laccase or no mediator or no laccase and no mediator were added.

### EXAMPLE 2

A reaction (500 microliter final volume) was set up as follows: 430 μl of 0.1 M citric acid-sodium phosphate buffer pH 5.0 supplemented with 0.25% Tween™ 80 surfactant and containing 4.4 μl NS42035 laccase (corresponding to 2 units, units as described above) was placed into a 3 ml glass vial. 50 μl of deep blue Australian blue cypress oil (Callitris intratropica) was then added. The reaction was started by the addition 20 μl of mediator methyl syringate prepared as 50 mM stock solution in ethanol. The glass vial was capped and incubated at 40° C. with constant agitation at 250 rpm on an orbital shaker. The progress of the decolouration was assessed after 3.5, 7 and 24 hours of incubation in comparison with the original colour, by stopping the reaction and extracting with isopropanol.

Particulate and precipitated materials were removed by centrifugation prior to analysis. After 24 hours of reaction the blue colour had completely disappeared, leaving a pale yellow to pale brownish oil suitable for use in fragrances. Decolouration was evaluated by absorbance measurement (Example 5) and gas chromatography analysis (GC-FID) (Example 6). Blank reactions were prepared and run the same way with the exception that no laccase or no mediator or no laccase and no mediator were added.

### EXAMPLE 3

6 essential oils were treated with laccase-mediator systems according to the procedure described in Example 1 and Example 2: Australian blue Cypress (Callitris intratropica), Eriocephalus punctulatus (South Africa), Wormwood Essence, Chamomile very heavy blue (Frith Farm), Chamomile Nepal, and Chiba oil Morocco (Artemisia sp.). The only changes were that the reactions were loaded with 2% oil only and that the reactions were run for 24 hours. The decolouration of the oils observed by eye was confirmed by GG-MS analysis with targeted detection of the four compounds azulene, chamazulene, guaiazulene and dihydrochamazulene. To this end, the reactions were extracted with 1 ml MTBE. The supernatant was evaporated. Residuals were suspended in 90 μl ethanol and diluted 100-fold for GC-MS analysis. 1 μl was splitless injected on to a 30 m×0.25 mm×0.25 μm VF-Wax Column (Varian) and developed with the following temperature gradient on a HP5890 GC apparatus: 2 mM at 35° C., 10° C./min to 50° C., 2.5° C./min to 240° C., 5 min at 240° C. The MS device SSQ7000 was from Thermo Finnigan. GC-MS analysis confirmed that decolouration was due to the disappearance of chamazulene, guaiazulene and/or dihydrochamazulene.

### EXAMPLE 4

Chiba oil was decoloured in a reaction as described in Example 1, with the exception that the oil load was only 1%. The following chemical compounds were used as mediators: sinapic acid, tyrosol, ethylvanillin, methylsyringate, arbutin, 1-hydroxybenzotriazole, TEMPO, phenothiazine, phenol red, 4-hydroxybenzoic acid, mesitol. As described in Example 1, the reactions were started by adding 20 microliter of a 50 mM mediator stock solution in ethanol. Control reactions without laccase mediator system or with laccase but no mediator were run. A blank reaction was run with oil placed in a reaction containing no laccase and no mediator. Reactions were stopped by extraction with isopropanol after 0, 2 and 7 hours of reaction as described in Example 1 and analysed with GC-FID as described in Example 6. Visual inspection of the oils after treatment indicated that the blue colour had disappeared, which was confirmed by the results obtained from GC-FID analysis summarized in the following table. Changes in the absorbance spectra recorded as described in Example 5 confirmed also the disappearance of the blue colour.

| | Chamazulene |
|---|---|
| Mediator | (% of start) |
| Blank | 80.2 |
| None | 10.4 |
| Sinapic acid | 1.9 |
| Tyrosol | 1.3 |
| Ethyl vanillin | 1.0 |
| Methyl syringate | 1.6 |
| Arbutin | 6.2 |
| 1-hydroxybenzotriazole | 2.7 |
| TEMPO | 1.5 |
| Phenothiazine | 3.3 |
| Phenol red | 1.6 |
| 4-hydroxybenzoic acid | 4.8 |
| mesitol | 2.6 |

### EXAMPLE 5

1 ml of the supernatant resulting from isopropanol extraction of the entire reaction volume was used for recording the absorption spectrum (500-800 nm) using a Cary 1 UV-VIS spectrophotometer (Varian). Changes in the recorded absorption spectrum between reaction start and reaction end confirmed the decolouration observed by visual inspection.

### Example 6

0.2 ml of the isopropanol extract was supplemented with 0.4 ml hexane for gas chromatography (GC-FID) analysis. The samples were chromatographed on a Zebron capillary column ZB-Waxplus (30 m×0.32 mm×0.25 μm) equipped with a 5 meter guard column. 1 μl was splitless injected; the column was developed in a FocusGC apparatus with the following temperature program: 3 min at 60° C., 8° C./min to 240° C., 10 min at 240° C. Chamazulene and guiazulene solutions made from authentic materials served as references for localization of the corresponding peaks in the chromatograms. The disappearance of these peaks from chromatograms obtained when chromatographing a sample of the decoloured oil confirmed that loss of the blue colour was due to removal of the azulenes.

1. A method of removing the blue colour from an azulene-containing essential oil, comprising adding of the oil to water buffered at pH 3-7.5 and, subsequently treating it with a laccase enzyme-mediator system, the laccase being selected from those derived from Trametes sp. and Myceliophthora thermophile optionally in the presence of a mediator.

2. A method according to claim 1, in which the mediator is selected from the group consisting of: sinapic acid, methyl syringate, arbutin, 1-hydroxybenzotriazole, TEMPO, phenothiazine, phenol red, 4-hydroxybenzoic acid, tyrosol, ethyl vanillin and mesitol.

3. A method according to claim 1, in which the mediator-laccase system is Trametes sp.-1-hydroxybenzotriazole.

4. A method according to claim 1, in which the mediator-laccase system is a Trametes sp.-derived laccase without added mediator.

5. A method according to claim 1, in which the mediator-laccase system is Myceliophthora thermophile-derived laccase with methyl syringate.

6. A method according to claim 1, in which a the mediator is present at a concentration is from 0.05-100 mM.

7. A method according to claim 1, in which the method is carried out at a pH in the range of 4.5-5.5.
